(19) United States
(12) Patent Application Publication
(10) Pub. No.: US 2010/0266068 A1
(43) Pub. Date: Oct. 21, 2010

(54) Low-IF terrestrial data receiver and related communication systems and methods

(76) Inventors: Lokesh K. Duraiappah, Austin, TX (US); Dana J. Taipale, Austin, TX (US); Wade R. Gillham, Austin, TX (US); George Tyson Tuttle, Austin, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 12/386,537

(22) Filed: Apr. 20, 2009

(51) Int. Cl. H04L 27/22

(52) U.S. Cl. 375/329

(57) ABSTRACT

Low-IF terrestrial data receivers and related communication systems and methods are disclosed that provide efficient solutions for reception of data services in FM broadcast channels. In particular, systems and methods are provided for data service information modulated on a 67.65 kHz sub-carrier, for example, using QPSK modulation. Intermediate data service information is output by the data receiver, and this intermediate data service information takes the form of demodulated digital I/Q signals provided through a digital interface of the data receiver. As such, partial digital signal processing is provided by the data receiver and the remaining digital processing is provided by a host processor.

### TECHNICAL FIELD OF THE INVENTION

This invention relates to communication systems for receiving and transmitting data and, more particularly, to receiving data service information on sub-carriers within an FM broadcast channel.

### BACKGROUND

For many electronic devices, such as cellular phones and portable devices, it is often desirable to have data communications. For example, many portable devices receive data services over FM broadcast channels. RDS/RBDS (radio data system/radio broadcast data system) is one such service that uses a 57 kHz sub-carrier within an FM broadcast channel to provide data such as traffic information. Microsoft DirectBand is another such service that uses a 67.75 kHz sub-carrier within an FM broadcast channel to provide data such as traffic, weather, gas prices and other information. In addition to this 67.75 kHz sub-carrier, DirectBand radio uses QPSK (Quadrature Phase Shift Keying) modulation and a data rate of 12 kbps. It is also noted that DirectBand is based upon Microsoft's earlier Smart Personal Objects Technology (SPOT), which has been utilized, for example, in smart watches.

RDS/RBDS and DirectBand are examples of information that is sent out on FM channels using modulated SCA (Subsidiary Communications Authorization) sub-carriers. These modulated sub-carriers are included in the FM channel broadcast transmission, and they can be received and demodulated using appropriate circuitry configured for reception of the particular SCA sub-carriers. U.S. Pat. No. 7,272,375, which is hereby incorporated by reference in its entirety, provides an example of low-IF FM receiver architectures that can receive and process RDS/RBDS data.

FIG. 1 (prior art) is a diagram for a FM broadcast channel, which is 200 kHz wide (±100 kHz from center frequency) in the United States. As depicted, the Left+Right mono audio signal is located from 30 Hz to 15 kHz. The Left−Right stereo audio signal are located in two bands from 25-38 kHz and from 38-53 kHz. The stereo pilot signal is located at 19 kHz. RBDS data is located in two bands on either side of a 57 kHz sub-carrier. DirectBand data is located in a band from 58.65-76.65 kHz with a sub-carrier frequency of 67.65 kHz. An additional Audio sub-carrier is located at 92 kHz.

Prior DirectBand receivers in portable devices utilized a chipset including an application chip and a DirectBand custom radio receiver chip. The application chip operates as a CPU (central processing unit) and is based upon an ARM processor. The DirectBand radio receiver chip was made specifically for the DirectBand and is how the MSN DirectBand service connects to the watch. FIG. 2 (prior art) provides an example embodiment 200 for such a DirectBand solution. A Microsoft FM radio tuner ASIC (Application Specific Integrated Circuit) 204 receives RF signals from antenna 202, including the DirectBand data signals in the FM broadcast channel being received. The FM radio tuner ASIC 204 outputs a signal to the ARM-based processor 206, which in turn outputs the DirectBand (DB) data 210 to the host processor 208. The host processor 208 is the processor that takes care of other functionality on the portable device.

The DirectBand receiver solution is relatively expensive, large, complex to manufacture and relatively non-integrated with many external components. As such, there is a need for a more efficient data receiver solution for DirectBand.

### SUMMARY OF THE INVENTION

Low-IF terrestrial data receivers and related communication systems and methods are disclosed that provide efficient solutions for reception of data services in FM broadcast channels. In particular, systems and methods are provided for data service information modulated on a 67.65 kHz sub-carrier, for example, using QPSK modulation. Intermediate data service information is output by the data receiver, and this intermediate data service information takes the form of demodulated digital I/Q signals provided through a digital interface of the data receiver. As such, partial digital signal processing is provided by the data receiver and the remaining digital processing is provided by a host processor.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 (prior art) is a diagram of an FM channel signal spectrum including the RDBS and DirectBand data services.

FIG. 2 (prior or art) is a block diagram for the prior DirectBand receiver solution.

FIG. 3 is a block diagram for the data receiver solution described herein.

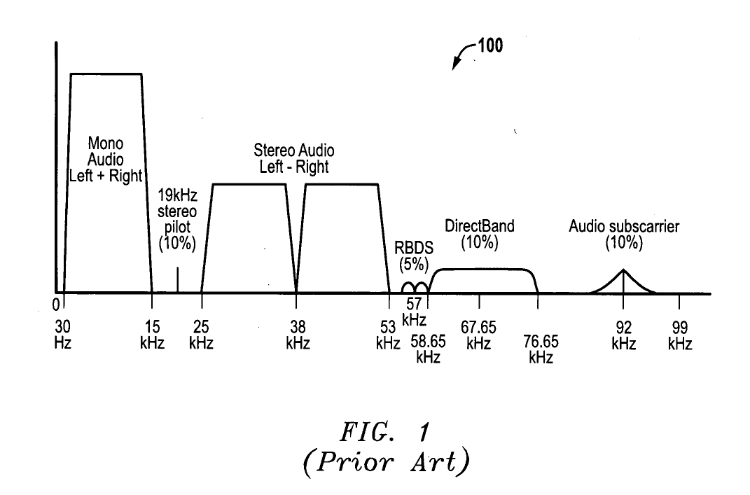

### DETAILED DESCRIPTION OF THE INVENTION

Low-IF terrestrial data receivers and related communication systems and methods are disclosed that provide efficient solutions for reception of data services in FM broadcast channels.

The low-IF terrestrial receivers and related systems and methods described here are designed to receive FM radio broadcast channel, perform FM demodulation and stereo decoding of the FM multiplex (MPX) signal to provide audio outputs, and perform decoding of Subsidiary Communications Authorization (SCA) sub-carriers multiplexed with the main stereo channel to provide ancillary music/data services. An example of these data services are RDS/RBDS and DIRECTBAND. More particularly, the solutions described herein provide a more efficient solution for receiving DirectBand data services.

FIG. 3 is a block diagram for an example embodiment 300 for an improved data receiver for data services with FM broadcast channels, such as the DirectBand data service. A low-IF FM data receiver 302 receives RF signals from antenna 202, including the DirectBand data signals in the FM broadcast channel being received. The FM data receiver 302 is a singled integrated circuit. A digital signal processor (DSP) 304 within the low-IF FM data receiver 302 includes a processing block 306 that provides partial processing of the DirectBand (DB) data in the FM broadcast channel. The low-IF FM data receiver 302 then outputs intermediate DirectBand (DB) data 310 to the host processor 208. The host processor 208 includes a digital signal processor (DSP) 308 having a processing block 309 that provides the remaining processing of the DirectBand (DB) data. The processing block 309 outputs the fully process DB data 210, which can then be further utilized within and/or output by DSP 308. In turn, the host processor 208 can utilize and/or output the DB data 210 for further use by the system or device. The DSP 304 and the DSP 308 can be implemented utilizing a wide variety of circuitry, including programmed microcontrollers, digital cores and/or other processors or circuitry, as desired. The communication between the integrated FM data receiver 302 and the host processor 208 can be implemented though a digital interface, such as a digital serial interface. Other interfaces could also be utilized, if desired.

With respect to the digital processing of the DirectBand data signals provided by the DSP 304 within the low-IF FM data receiver 302, it is noted that in one embodiment, the DSP 304 can perform FM demodulation and demodulation of the DirectBand QPSK modulated sub-carrier. For this embodiment, the FM data receiver 302 then outputs digital, demodulated I and Q (i.e., in-phase and out-of-phase) digital data signals through the digital output interface to the host processor 208. The host processor 208 then processes this intermediate digital I/Q data to obtain fully processed DirectBand data.

Examples of digital serial interfaces that could be used include the following: I2S interface (Inter-IC Sound Interface) and similar bit-stream formats, as well as time division multiplexing (TDM) streams. Other digital serial interfaces could also be used. If desired, the digital serial interface can also be programmed to support one or more of the following options on the basic serial protocol: (1) master or slave mode, (2) programmable clock and word select polarity (rising or falling edge), (3) slot length (number of bits per time slot), (4) word length (bits per word): always less than or equal to the time slot length, (4) first-bit data delay with respect to the word select, (5) left/right alignment of word inside slot, (6) bit order: most-significant-bit first or least-significant-bit first, and/or (7) bit mask/pad/rotate function. It is further noted that in master mode the integrated FM data receiver is configured to generate the bit clock and word select lines with the serial data lines to the host processor. In slave mode, the integrated FM data receiver is configured to accept external bit clock and word select lines in generating the serial data line outputs.

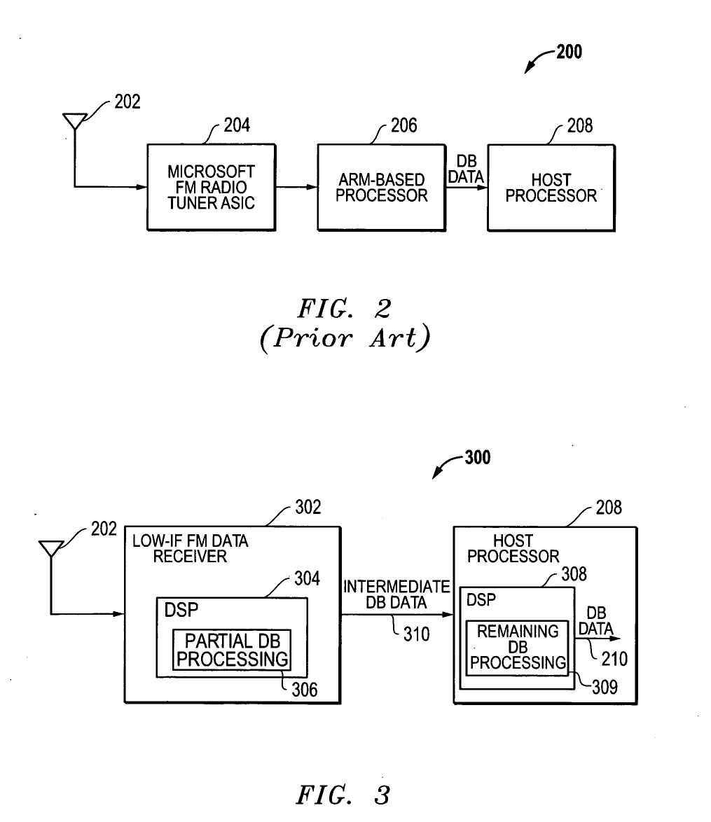

Advantageously, the low-IF data receiver solutions described herein partition the DirectBand processing between the FM data receiver 302 and the host processor 208 thereby eliminating the need for the additional ARM processor and integrated circuit in FIG. 2 (prior art). In particular, by including partial data processing within the DSP 304 of the FM data receiver 302 and by including remaining data processing with the DSP 308 of the host processor 208, there is no need for the additional processor integrated circuit required by the prior solution of FIG. 2 (prior art). It is further noted that the partitioned data processing solution described herein could be utilized for other data services if desired.

It is further noted that the digital processing provided in the integrated FM data receiver 302 can include digital filter, tuning and demodulation of the data service information in the received FM broadcast channel. In such an embodiment, the integrated FM data receiver 302 outputs digital demodulated data service information through a digital interface for the integrated FM data receiver 302. The host processor 208 can then provide further digital processing in the form of digital decoding of the digital demodulated data service information to produce fully processed (e.g., demodulated and decoded) data service information. It is noted, therefore, that the data service information can be coded using a desired coding scheme, and the DSP 308 within the host processor 208 can be configured to provide appropriate decoding of this coded information. The fully processed output data 210 can then represent demodulated and decoded data service information. It is again noted that the DSP 308 can be implemented using a wide variety of circuitry, including programmed microcontrollers, digital cores and/or other processors or circuitry, as desired.

An example of low-IF FM receiver architectures that could be utilized for the low-IF FM data receivers are described in U.S. Pat. No. 7,272,375, which is hereby incorporated by reference in its entirety. For example, receive path circuitry within an integrated FM receiver can receive an RF signal spectrum representing an FM broadcast channel including data service information on a sub-carrier and can output digital signals representing the data service information. A DSP within the integrated FM receiver can then process the data service information to produce intermediate data service information. This intermediate data service information can then be output through a digital interface to an external device such as a host processor. The DSP can be implemented utilizing a wide variety of circuitry, including a microcontroller programmed to implement the desired partial processing.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. An integrated data receiver for data services with an FM broadcast channel, comprising:
receive path circuitry within an integrated circuit configured to receive an RF signal spectrum representing an FM broadcast channel including data service information modulated on a 67.65 kHz sub-carrier within the FM broadcast channel using QPSK modulation and configured to provide digital output signals representing the modulated data service information;
a digital signal processor within the integrated circuit coupled to receive the digital output signals from the receive path circuitry and configured to demodulate the QPSK modulated data service information to provide digital output signals representing intermediate demodulated data service information; and
a digital interface within the integrated circuit, the digital interface configured to output the digital output signals representing the intermediate demodulated data service information for further processing by an external device to generate fully processed data service information.

2. The integrated data receiver of claim 1, wherein the digital output signals representing intermediate demodulated data service information comprise I and Q digital data signals.

3. The integrated data receiver of claim 1, wherein the receive path circuitry comprises low-IF receiver path circuitry.

4. The integrated data receiver of claim 1, wherein the digital interface comprises an I2S digital interface.

5. The integrated data receiver of claim 1, wherein the digital interface is configured to operate in a master mode or in a slave mode.

6. A data service system for data services with an FM broadcast channel, comprising:
an integrated data receiver, comprising:
receive path circuitry within an integrated circuit configured to receive an RF signal spectrum representing an FM broadcast channel including data service information modulated on a 67.65 kHz sub-carrier within the FM broadcast channel using QPSK modulation and configured to provide digital output signals representing the modulated data service information;
a digital signal processor within the integrated circuit coupled to receive the digital output signals from the receive path circuitry and configured to demodulate the QPSK modulated data service information to provide digital output signals representing intermediate demodulated data service information; and
a digital interface within the integrated circuit, the digital interface configured to output the digital output signals representing the intermediate demodulated data service information;
an integrated host processor, comprising:
a digital interface within the integrated host processor configured to receive the digital output signals representing the intermediate demodulated data service information; and
a digital signal processor within the integrated host processor coupled to receive the intermediate demodulated data service information from the digital interface and to process the intermediate demodulated data service information to produce fully processed data service information.

7. The data service system of claim 6, wherein the data service information is coded and wherein digital signal processor within the integrated host processor is configured to decode the digital output signals from the integrated data receiver to produce fully processed data service information.

8. The data service system of claim 6, wherein the digital output signals representing intermediate demodulated data service information comprise I and Q digital data signals.

9. The data service system of claim 6, wherein the receive path circuitry comprises low-IF receiver path circuitry.

10. The data service system of claim 6, wherein the digital interface for the integrated data receiver and the integrated host processor comprise I2S digital interfaces.

11. The data service system of claim 6, wherein the digital interface for the integrated data receiver is configured to operate in a master mode and the digital interface for the integrated host processor is configured to operate in a slave mode, or wherein the digital interface for the integrated data receiver is configured to operate in a slave mode and the digital interface for the integrated host processor is configured to operate in a master mode

12. A method for receiving data services with an FM broadcast channel, comprising:
receiving with an integrated circuit an RF signal spectrum representing an FM broadcast channel including data service information modulated on a 67.65 kHz sub-carrier using QPSK modulation;
generating within the integrated circuit digital signals representing the modulated data service information;
processing within the integrated circuit the digital signals to demodulate the digital signals to produce digital output signals representing intermediate demodulated data service information; and
outputting the digital output signals representing the intermediate demodulated data service information through a digital interface for the integrated circuit to an external device.

13. The method of claim 12, wherein the digital output signals representing intermediate demodulated data service information comprise I and Q digital data signals.

14. The method of claim 12, wherein the receive path circuitry comprises low-IF receiver path circuitry.

15. The method of claim 12, further comprising
receiving the digital output signals representing intermediate demodulated data service information through a digital interface on an integrated host processor; and
further processing the intermediate demodulated data service information to produce fully processed data service information.

16. The method of claim 15, wherein the data service information is coded and wherein the further processing step comprises decoding the digital output signals from the integrated data receiver to produce fully processed data service information.

17. The method of claim 15, wherein the digital output signals representing intermediate demodulated data service information comprises I and Q digital data signals.

18. The method of claim 15, wherein the receive path circuitry comprises low-IF receiver path circuitry.

19. The method of claim 15, wherein the digital interface for the integrated data receiver and the integrated host processor comprise I2S digital interfaces.

20. The data service system of claim 15, further comprising configuring the digital interface for the integrated data receiver to operate in a master mode or in a slave mode.
